(19) United States
(12) Patent Application Publication
(10) Pub. No.: US 2016/0323789 A1
(43) Pub. Date: Nov. 3, 2016

(54) Method for UE distribution in Overlaying Layers based on Estimated Coverage

(71) Applicant: Nokia Solutions and Networks Oy, Espoo (FI)

(72) Inventors: Venkataramanan Narayanan, Huntley, IL (US); Vivek Naik, Deerfield, IL (US); William Thompson, Cary, IL (US)

(73) Assignee: Nokia Solutions and Networks Oy

(21) Appl. No.: 14/700,208

(22) Filed: Apr. 30, 2015

(51) Int. Cl. H04W 36/04; H04W 36/00; H04W 36/22

(52) U.S. Cl. CPC H04W 36/04; H04W 36/22; H04W 36/0094

(57) ABSTRACT

In accordance with exemplary embodiments, at least apparatus, methods, and computer program products perform selection of a reduced set of overlaying cells to provide access to a UE from a set of overlaying cells in a network using one or more RATs and multiple different frequencies and whose coverage areas for the cells in the set partially or completely overlay each other. The selection is based on location of the UE within the overlaying cells and estimates of coverage areas of the overlaying cells derived based on information including at least one of angles of arrival and reception-transmission difference information for UEs in the network. Distribution is performed of UEs across the selected overlaying cells based on a desired statistical distribution for the UEs across the cells in the reduced set of cells. The desired statistical distribution takes into account the one or more RATs and the multiple different frequencies.

### TECHNICAL FIELD

This invention relates generally to wireless communication and, more specifically, relates to distribution of UEs in wireless networks.

### BACKGROUND

This section is intended to provide a background or context to the invention disclosed below. The description herein may include concepts that could be pursued, but are not necessarily ones that have been previously conceived, implemented or described. Therefore, unless otherwise explicitly indicated herein, what is described in this section is not prior art to the description in this application and is not admitted to be prior art by inclusion in this section. Acronyms used in the specification and/or drawings are defined below, prior to the claims.

Over the past year due to rapid growth in data traffic, operators are deploying additional LTE carriers to maintain and/or improve user experience. These new carriers can overlay the original carriers and provide improved bandwidth, which improves user experience. One way of conceptualizing this type of system is through the use of layers, which are mapped to a cell and include frequency and possibly other characteristics (such as radio access technologies) to distinguish between the layers. In such multi-band radio access deployment using one or various technologies, there is a need to distribute UEs in a geographical area across overlying layers to maximize the use of the entire available spectrum.

One commercially deployed approach to distribute the UEs is to load balance without additional RRC signaling messages based, e.g., on operator configured thresholds or a round robin mechanism during the release of the UE as it is being transitioned to idle mode. This technique works well when multiple frequencies are deployed in the same band, as each of the frequencies have similar coverage. As an example, the frequency band referred to as number 18 in EUTRAN may have downlink EUTRAN frequencies of 860 MHz, 875 MHz. These would have similar coverage areas, which may be considered to be an area over which a UE can connect to a base station using the particular frequency range.

There are certain problems, described below, which may occur when attempting to distribute the UEs, e.g., to perform load balancing at the time of transitioning UEs to idle mode.

### SUMMARY

This section contains examples of possible implementations and is not meant to be limiting.

A method includes selecting, from a set of overlaying cells using one or more radio access technologies and a plurality of different frequencies and whose coverage areas for the cells in the set partially or completely overlay each other, a reduced set of overlaying cells to provide access to user equipment, wherein the selection is based on location of the user equipment within the overlaying cells and estimates of coverage areas of the overlaying cells. The method further includes performing distribution of user equipment across the selected overlaying cells based on a desired statistical distribution for the user equipment across the cells in the reduced set of cells, wherein the desired statistical distribution takes into account the one or more radio access technologies and the plurality of different frequencies.

An additional exemplary embodiment includes a computer program, comprising code for performing the method of the previous paragraph, when the computer program is run on a processor. The computer program according to this paragraph, wherein the computer program is a computer program product comprising a computer-readable medium bearing computer program code embodied therein for use with a computer.

An exemplary apparatus includes one or more processors and one or more memories including computer program code. The one or more memories and the computer program code are configured to, with the one or more processors, cause the apparatus to perform at least the following: selecting, from a set of overlaying cells using one or more radio access technologies and a plurality of different frequencies and whose coverage areas for the cells in the set partially or completely overlay each other, a reduced set of overlaying cells to provide access to user equipment, wherein the selection is based on location of the user equipment within the overlaying cells and estimates of coverage areas of the overlaying cells; and performing distribution of user equipment across the selected overlaying cells based on a desired statistical distribution for the user equipment across the cells in the reduced set of cells, wherein the desired statistical distribution takes into account the one or more radio access technologies and the plurality of different frequencies.

An exemplary computer program product includes a computer-readable storage medium bearing computer program code embodied therein for use with a computer. The computer program code includes: code for selecting, from a set of overlaying cells using one or more radio access technologies and a plurality of different frequencies and whose coverage areas for the cells in the set partially or completely overlay each other, a reduced set of overlaying cells to provide access to user equipment, wherein the selection is based on location of the user equipment within the overlaying cells and estimates of coverage areas of the overlaying cells; and code for performing distribution of user equipment across the selected overlaying cells based on a desired statistical distribution for the user equipment across the cells in the reduced set of cells, wherein the desired statistical distribution takes into account the one or more radio access technologies and the plurality of different frequencies.

Another exemplary embodiment is an apparatus comprising: means for selecting, from a set of overlaying cells using one or more radio access technologies and a plurality of different frequencies and whose coverage areas for the cells in the set partially or completely overlay each other, a reduced set of overlaying cells to provide access to user equipment, wherein the selection is based on location of the user equipment within the overlaying cells and estimates of coverage areas of the overlaying cells; and means for performing distribution of user equipment across the selected overlaying cells based on a desired statistical distribution for the user equipment across the cells in the reduced set of cells, wherein the desired statistical distribution takes into account the one or more radio access technologies and the plurality of different frequencies.

### BRIEF DESCRIPTION OF THE DRAWINGS

In the attached Drawing Figures:

FIG. 1 is a block diagram of an exemplary system in which embodiments may be practiced.

FIG. 2 is an example of multiple sectorization of cells of different coverage created by an eNB;

FIG. 3 is a graph showing cell ranges with an Okumura-Hata Propagation Model;

FIG. 4 is a graph illustrating LTE UE access distribution percentage (%);

FIG. 5 is a graph illustrating UE access distance comparisons across overlying bands for a desired 50:50 distribution;

FIG. 6A is Table 1, which is an example of a possible operator-provisioned data structure used for load balancing UEs at the time of transitioning to idle mode;

FIG. 6B is Table 2, which is an example of a possible SON-derived data structure used for load balancing UEs at the time of transitioning to idle mode;

FIG. 7 is a logic flow diagram for distributing (e.g., load balancing) UEs at the time of transitioning to idle mode based on access distance and angle of arrival (AoA), and illustrates the operation of an exemplary method, a result of execution of computer program instructions embodied on a computer readable memory, functions performed by logic implemented in hardware, and/or interconnected means for performing functions in accordance with examples of embodiments;

FIG. 8 is a graph illustrating behavior based on distributing (e.g., load balancing) UEs at the time of transitioning to idle mode without this invention; and

FIG. 9 is a graph illustrating behavior based on an example implementation with this invention.

### DETAILED DESCRIPTION OF THE DRAWINGS

As indicated above, there are certain problems, which may occur when attempting to distribute the UEs at the time of transitioning to idle mode. These problems and example solutions are presented after a system into which examples of embodiments may be used is described.

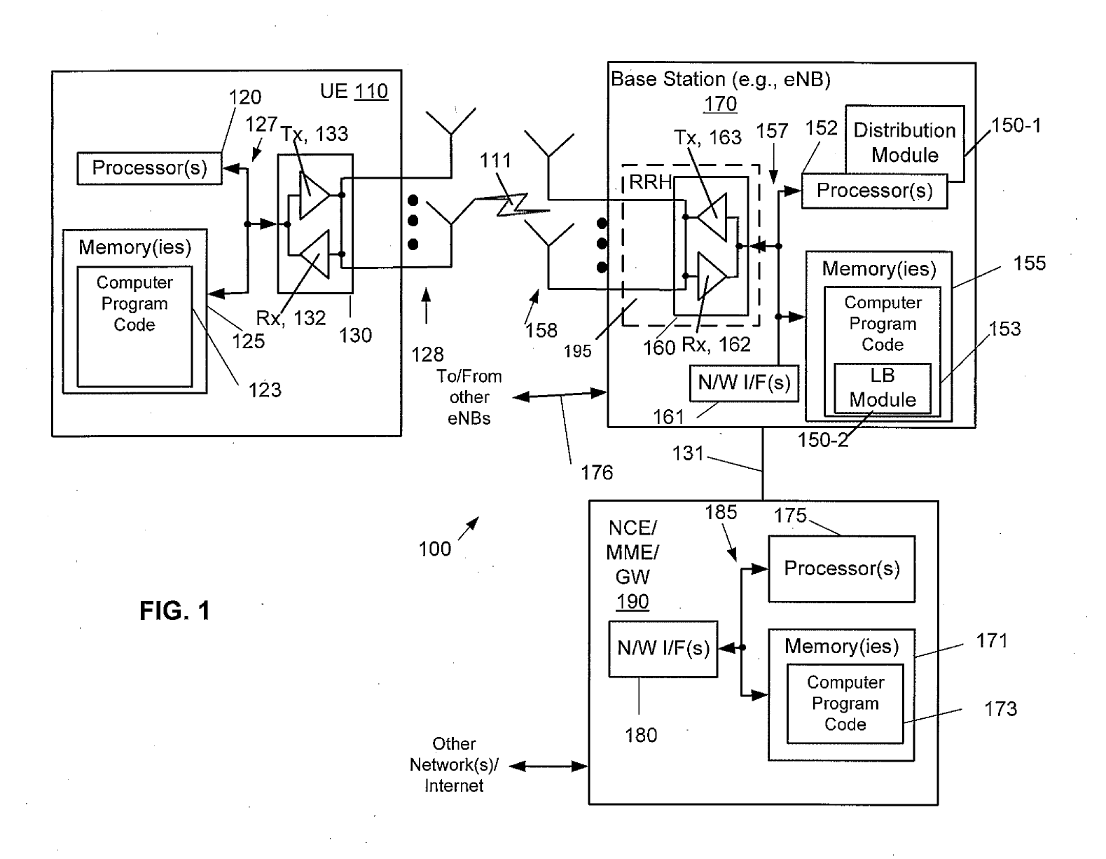

Turning to FIG. 1, this figure shows a block diagram of an example of a system in which example embodiments may be practiced. In FIG. 1, a UE 110 is in wireless communication with a wireless network 100. The user equipment 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. For instance, the one or more memories 125 and the computer program code 123 may be configured to, with the one or more processors 120, cause the user equipment 110 to perform one or more of the operations as described herein. The UE 110 communicates with eNB 170 via a wireless link 111.

The base station 170 is a network node that provides access by wireless devices such as the UE 110 to the wireless network 100. The base station 170 may be an eNB supporting LTE systems or another radio access network supporting other systems such as legacy 3GPP systems or some combination of these. For instance, the base station 170 could include base transceiver station/NodeB and/or RNC functionality. For ease of reference, the base station 170 is considered to be an eNB with the ability to be in deployments such as legacy 3GPP and LTE systems.

The eNB 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153.

The eNB 170 includes a distribution module 150 that performs distribution (e.g., load balancing) of UEs at the time of transitioning to idle mode. The module 150 may therefore be considered to be a distributing UEs at the time of transitioning to idle mode module 150. For ease of reference, this module will be referred to as the distribution module 150. The distribution module 150 comprises one of or both parts 150-1 and/or 150-2, which may be implemented in a number of ways. The distribution module 150 may be implemented in hardware as module 150-1, such as being implemented as part of the one or more processors 152. The distribution module 150-1 may be implemented also as an integrated circuit or through other hardware such as a programmable gate array. In another example, the distribution module 150 may be implemented as load balancing mode module 150-2, which is implemented as computer program code 153 and is executed by the one or more processors 152. For instance, the one or more memories 155 and the computer program code 153 are configured to, with the one or more processors 152, cause the eNB 170 to perform one or more of the operations as described herein. The one or more network interfaces 161 communicate over a network such as via the links 176 and 131. Two or more eNBs 170 communicate using, e.g., link 176. The link 176 may be wired or wireless or both and may implement, e.g., an X2 interface.

It is noted that description herein indicates that “cells” perform functions, but it should be clear that the eNB that forms the cell will perform the functions. A cell makes up part of an eNB. That is, there can be multiple cells per eNB. For instance, there could be three cells for a single eNB carrier frequency and associated bandwidth, each cell covering one-third of a 360 degree area so that the single eNB's coverage area covers an approximate oval or circle. Furthermore, each cell can correspond to a single carrier and an eNB may use multiple carriers. So if there are three 120 degree cells per carrier and two carriers, then the eNB has a total of six cells.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195, with the other elements of the eNB 170 being physically in a different location from the RRH, and the one or more buses 157 could be implemented in part as fiber optic cable to connect the other elements of the eNB 170 to the RRH 195.

The wireless network 100 may include a network control element (NCE) 190 that may include MME/SGW functionality, and which provides connectivity with a further network, such as a telephone network and/or a data communications network (e.g., the Internet). The eNB 170 is coupled via a link 131 to the NCE 190. The link 131 may be implemented as, e.g., an SI interface. The NCE 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the NCE 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples.

In general, the various embodiments of the user equipment 110 can include, but are not limited to, cellular telephones such as smart phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

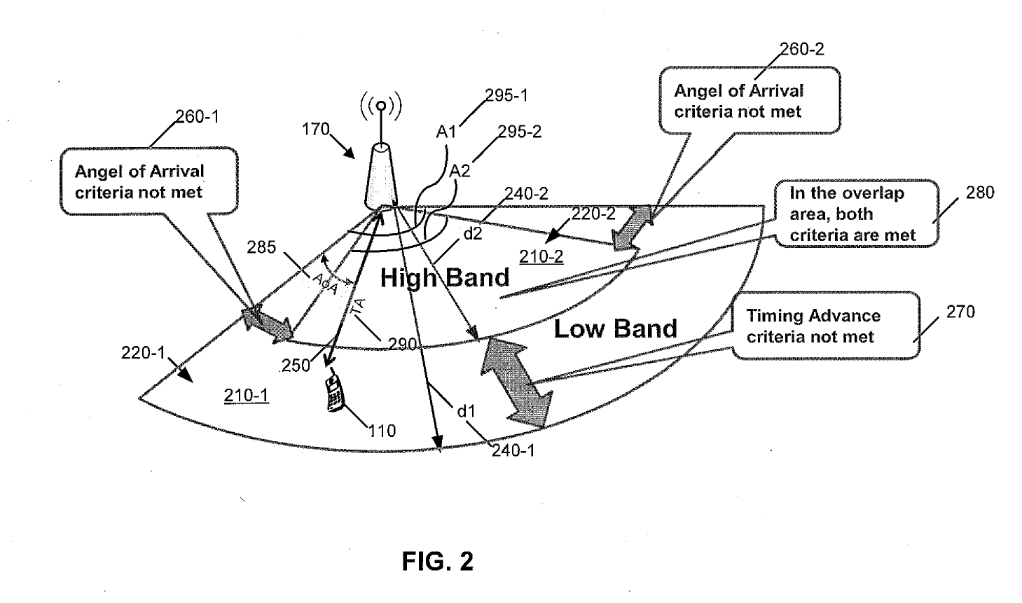

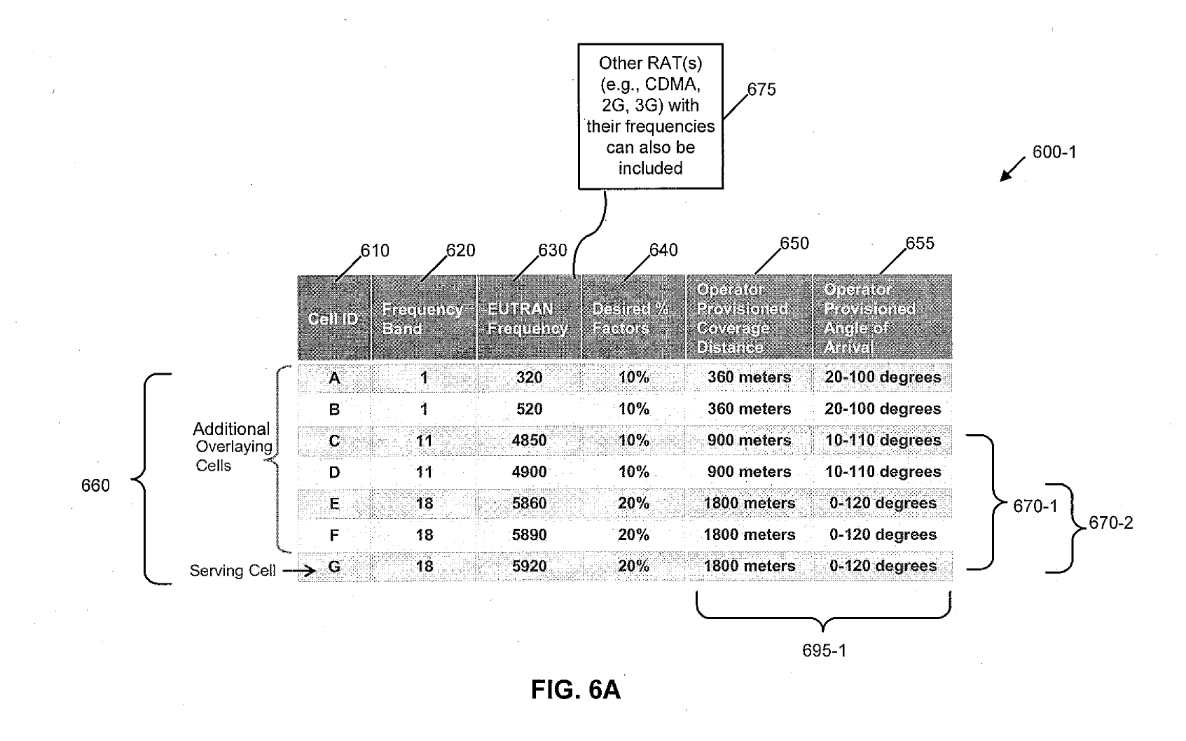

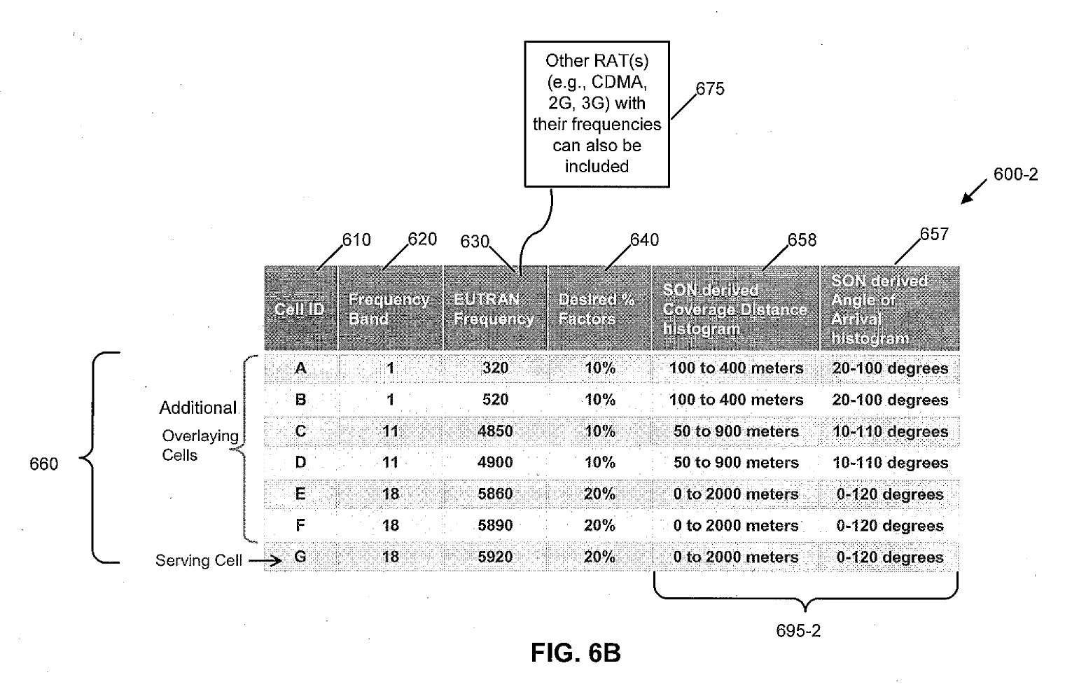

Turning to FIG. 2, this figure shows an example of multiple cells 220-1 and 220-2 of different coverage areas 210-1 and 210-2 created by an eNB 170. FIG. 2 shows sectorization for accurate representation of a typical deployment. Each cell 220 corresponds to its coverage area 210. In this example (and the examples used herein), each coverage area 210 is represented by a coverage distance 240-1 d1 or 240-2 d2 and possibly angular coverage (illustrated by angles A1 295-1 and A2 295-2, which shows that the two cells may have different angular coverage). Cell 220-1 may use a low band frequency (e.g., 800 MHz) and cell 220-2 could use a high band frequency (e.g., 1.9 GHz or 2.1 GHz). The coverage areas 210 are assumed to be defined by coverage distances 240-1 d1, 240-2 d2, angular coverages defined by angles A1 295-1, A1 295-2 and are assumed to be sectors of circular shapes such that each coverage distance 240-1 d1 or 240-2 d2 is a radius of the corresponding sector and angular coverages defined by angles A1 295-1, A1 295-2 are the angular range of the corresponding sector. However, there may be other shapes used to define a coverage area 210, such as an oval (e.g., using two different coverage distances, one for each axis of the oval) or even more complex shapes. Another characteristic of cell coverage is the angular coverage of a cell. Additionally, only two different coverage areas 210 are shown, but there could be more than two coverage areas 210, as described below in reference to FIGS. 6A and 6B. Also, only one eNB 170 is assumed to create the multiple cells 220, but multiple eNBs may be used to create the multiple cells 220 and coordinated, e.g., using a SON server, to perform the operations described herein. An eNB 170 can determine for a UE 110 accessing location 250 a cell based on radial distance of the UE derived from timing advance 290 and AoA 285 of the UE 110.

Overlapping cells will have areas where there is coverage overlap from both cells and areas where only a subset of the cells provides coverage. In this example, there are locations 260-1 and 260-2 where the angle of arrival (AoA) criteria are not met and location 270 where the timing advance (TA) criteria are not met. As indicated by reference 280, both the AoA and the TA criteria are met in the overlap area. The UE 110 has an AoA 285 that does meet the AoA criteria. The UE 110 also has a timing advance (TA) 290 that does not meet timing advance criteria, as illustrated by reference 270. As both criteria are not met, the UE is considered not in the cell coverage overlap area.

Also shown is an access distance 250, which is a distance from the eNB 170 to the UE 110 at a point at which the UE is accessing the radio network. The AoA (usually azimuth) in an angle from which a signal arrives relative to a reference angle of an antenna array.

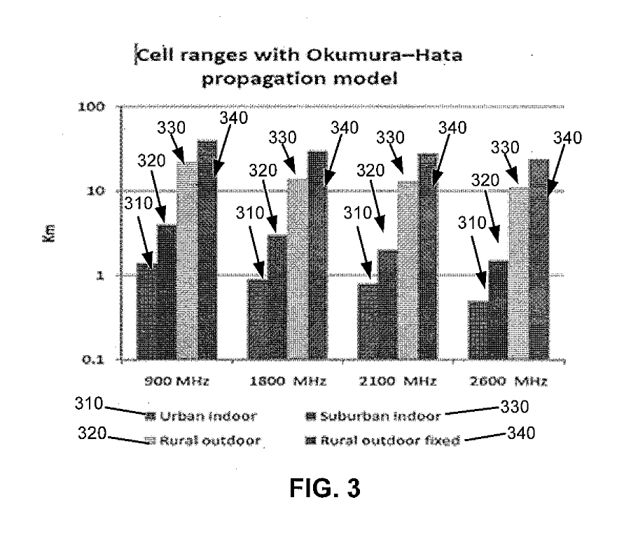

As stated above, there are certain problems, which may occur at the time of attempting to distribute the UEs at a time of transitioning to idle mode. For example, in a multi-band, multi-frequency deployment, the cell coverage area 210 differs based on the band used as can be seen in the propagation model of FIG. 3, showing cell ranges (e.g., coverage distances 240) with an Okumura-Hata Propagation Model. The coverage is shown in kilometers. For the frequencies of 900, 1800, 2100, and 2600 MHz, the cell range is shown for urban indoor 310, suburban indoor 320, rural outdoor 330, and rural outdoor fixed 340 models. It can be seen that the actual cell ranges vary depending on the frequency and model being used.

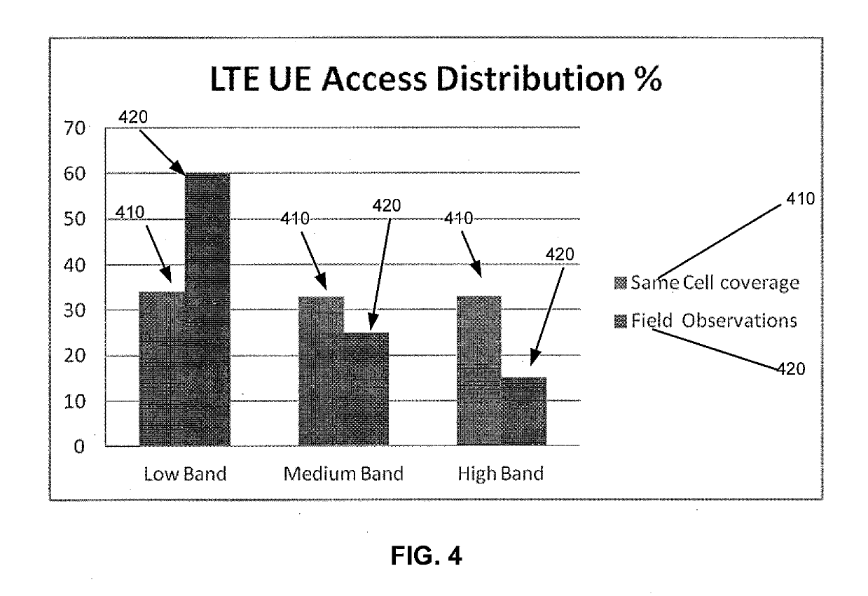

The load balancing UEs at the time of transitioning to idle mode approach works well when the overlying cells have the same coverage. It has been observed in the commercial deployment that the UEs are unevenly distributed in a multi-band multi-frequency deployment due to the difference in cell coverage. This is illustrated by FIG. 4, which is a graph illustrating LTE UE access distribution percentage (%). This shows same cell coverage 410, which should be about a 33 percent UE access distribution for each of the high band, medium band and low band frequencies. Each set (high, medium, and low) of frequencies can be considered to be a band class, and each band class contains some range of frequencies. It is noted that field observations 420 show that the UE access distributions are skewed toward the lower frequencies and a corresponding band class, resulting in uneven load distribution.

Thus, the load balancing UEs at the time of transitioning to idle mode approach used in a multi-band multi-frequency deployment does not meet the objective of load balancing, as the UE access distribution does not reflect the factors provisioned by the operator. To overcome this, the following methods have been attempted.

Method 1. In this method, an operator artificially biases the operator-provisionable distribution factors in such a way that the desired distribution is achieved. In particular, in this method, a weighted round-robin scheme to select the target layer (e.g., frequency and corresponding cell) to which a UE shall be released with dedicated cell re-selection priority. The ratio of UEs for which the load balancing at the time of transitioning to idle mode is applied is controlled by operator-provisioned settings. The operator provisions the weighting factor used for each configured intra-LTE and inter-RAT cell re-selection target. At the time of sending RRC: RRC Connection Release message to the UE, the serving cell determines based on operator-provisioned factors which overlaying layer should be given the highest priority. The target layer selection is based on the weights and the round robin scheme, thus the operator can distribute UEs in a geographical area across the overlaying layers.

For example, in a typical operator scenario with a low and high band LTE deployment with equal bandwidth and capacity, the operator desires to achieve a 50:50 distribution across the layers. But, due to unequal coverage between high and low bands, the distribution factors have to be provisioned such that higher factor of UEs are sent from low band to high band. This increases the number of UEs on the high band, decreases the utilization of low band and increases the utilization on the high band to match the utilization of the low band. In this approach, the biased weighting factor is applied to all UEs in the low band. This adversely impacts the UEs on the lower band, where there is no overlaying high band coverage. In the areas where the higher frequency band coverage is not available, the UEs fail to access the higher band and re-acquire the lower band. This adversely affects the battery life of the UE (estimated at about 6-10 percent) due to unproductive inter-frequency cell reselections. Further, during the reselection window, the UE is unavailable for data traffic.

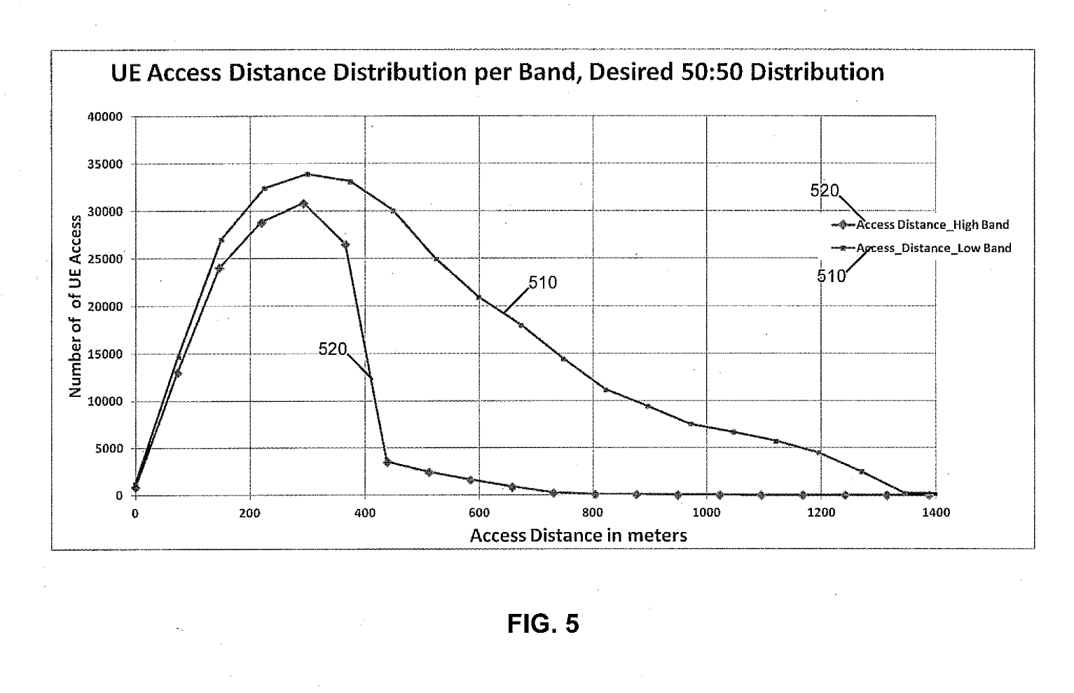

FIG. 5 is a graph illustrating UE access distance 250 comparisons across overlying bands and is based on data from commercial deployment. In this deployment, the intent is to distribute all UEs evenly across both the bands as part of load balancing UEs at the time of transitioning to idle mode functionality.

More particularly, the plots in FIG. 5 are UE access distance distribution on each band. The plot 510 refers to the distribution for a high band cell site and the plot 520 for a low band cell site, which overlay each other. Example, majority of all the UEs are accessing high band access at a distance less than 450 meters (m). Typically, the higher band site will have smaller cell coverage due to higher propagation losses on the higher bands as compared to a lower band site. The plots show that about 95 percent of the UEs which access high band sites are within 400 m, versus for low band site it is about 1000 m. The plot is taken from a commercial deployment where the operator is using a 50:50 distribution across the low band and the high band. Thus the graph reflects that until about 500 m almost all accesses are distributed evenly between the two bands, and the high band access tapers beyond that as the cell coverage fades. UEs beyond 500 m can access only the low band, as there is no coverage from the high band. Thus the UE accesses for low band are seen beyond 500 m.

Method 2). An alternative method is to perform inter-frequency measurement at the UE 110 to determine which cells are providing access at its location prior to determining the target carrier and corresponding cell for load balancing UEs at the time of transitioning to idle mode. The enhanced approach would be for the eNB to determine the layers which are available for the UE at the location of the UE. This can be achieved by performing the measurement of the overlaying inter-frequency layers before releasing the UE. Based on the UE measurement report, the eNB acts to send the UE to a target layer which is available at the UE location. If there is no overlaying frequency available, then the UE will stay in the serving carrier.

This approach leads to N+1 RRC messages (N is the number of overlying frequencies) to and from the UE before release. This approach can help in achieving the desired UE distribution, but it has the following possible disadvantages:
The UE battery life is impacted due to inter-frequency measurement performed before release; and
Additional RRC signaling messages impact the cell capacity and thus are not desired in a loaded condition.

So, solutions which address the above short comings are needed.

The examples herein propose examples of algorithms and devices for performing the algorithms to enhance the Method 1 load balancing UEs at the time of transitioning to idle mode solution. The enhancement in an example embodiment is based on the eNB 170 considering the following factors at the time of making a decision to release the UE:

1) UE access distance 250 within the cell site. This can be derived, for instance, using UE Rx-Tx difference information and the Angle of Arrival (AoA) measurements available for the UE at the eNB. Other possible techniques for determining access distances are described below.

2) Access coverage distances 240 of each of the overlying band classes. This can be based on an operator-provisioned data structure 600 as shown in Table 1 (see FIG. 6A) and Table 2 (FIG. 6B). FIG. 6A is an example of a possible operator-provisioned data structure 600-1 and FIG. 6B is an example of a possible SON-derived data structure 600-2 used for load balancing UEs at the time of transitioning to idle mode. The data structure 600 includes a number of cell IDs 610 (of which there are A-G of them and each of these correspond to a cell 220), frequency bands 620, EUTRAN frequencies 630, and desired percentage (%) factors 640. The desired percentage factors 640 column contains the percentages of UEs the eNB attempts to distribute to each layer. In this case, the eNB 170 (e.g., or SON server) attempts to have 40% of UEs distributed evenly to cells with cell IDs A-D (each with 10% of the UEs) and attempts to have 60% of UEs distributed evenly to cells with cell IDs E, F, and G (each with 20% of the UEs). Operator-provisioned data structure 600-1 includes operator-provisioned coverage distances 650 and operator-provisioned angles of arrival 655, both of which are provisioned (e.g., set) by the operator. A coverage area profile 695 (e.g., 695-1 in this example) for each cell may include one or both of operator-provisioned coverage distances 650 and/or operator-provisioned angles of arrival 655. SON-derived data structure 600-1 includes SON-derived coverage distance histogram 658 and SON-derived angles of arrival histogram 657, both of which are determined (e.g., set) by a SON using a histogram of actual coverage distances and angles of arrival. A coverage area profile 695 (e.g., 695-2 in this example) for each cell may include one or both of SON-derived coverage distance histogram 658 and/or SON-derived angles of arrival histogram 657. A coverage distance is a maximum distance beyond which the UE cannot access the cell. The serving cell is the cell to which the UE is connected for service, and the overlaying cells are additional cells to which the UE can connect at its location. Note that the serving cell also overlies the overlying cells (and vice versa, the overlying cells overlie the serving cell, at least to some degree).

With overlapping layers in an area, one example of an implementation is to have an effective distribution of UEs across these layers such that the UEs are accessing on different layers at the desired percentage factors. Each overlaying layer is associated with a unique cell, and the serving cell is the cell to which the UE is connected for service. In this method, the serving cell determines which layer the UE should be sent to so that the distribution of UEs in an area across overlaying layers is maintained.

It is noted that the data such as in FIGS. 6A and 6B and other figures herein are for different frequencies from the same or different bands. However, the techniques herein will equally apply to heterogeneous networks, where different layers provide varying cell coverage.

An alternative approach to the coverage distances 650 is for the eNB 170 to self-learn the coverage details based on access distances 250 and the distances at which inter-frequency handovers are attempted from a high frequency band cell to a lower frequency band cell for coverage reasons. These coverage distances are shown as coverage distance histogram 658. In the self-learning approach, it is possible in an exemplary embodiment that SON-based procedures will be used to perform the following:
collect such access distance data from each overlying cell 220;
determine overlying cells (such as cell pairs) based on site information; and
share the access distance data across overlying cells.

In the example of FIG. 6B, the SON-derived coverage distance histogram 658 is one example of coverage distances that can be determined using these SON-based procedures.

In addition to access distances 250, the angle of arrival can be also added as a decision metric. The angle of arrival for the operator-provisioned coverage angles of arrival 655 and the SON-derived angles of arrival histogram 657 are examples of this. If a UE is within the range of angles (e.g., 20-100 degrees for Cell IDs A and B), then the UE may be assigned to one of the cells having a cell ID A or B; if the UE is outside this range of angles, the UE is not assigned to one of the cells having the cell ID A or B. The references 660 and 670 are described below.

The examples herein are not limited to a single radio access technology such as E-UTRAN. Another possibility, for instance, for the tables 600-1 and 600-2 is illustrated by FIG. 6A and reference 675, where other RAT(s) (e.g., CDMA, second generation (2G), third generation (3G) technologies, or the like) with their corresponding frequencies would also be included in the tables 600-1 and 600-2. Although not shown, the other RAT(s) and their corresponding frequencies would also have the information in reference numerals 640, 650, 655, 657, or 658, as applicable.

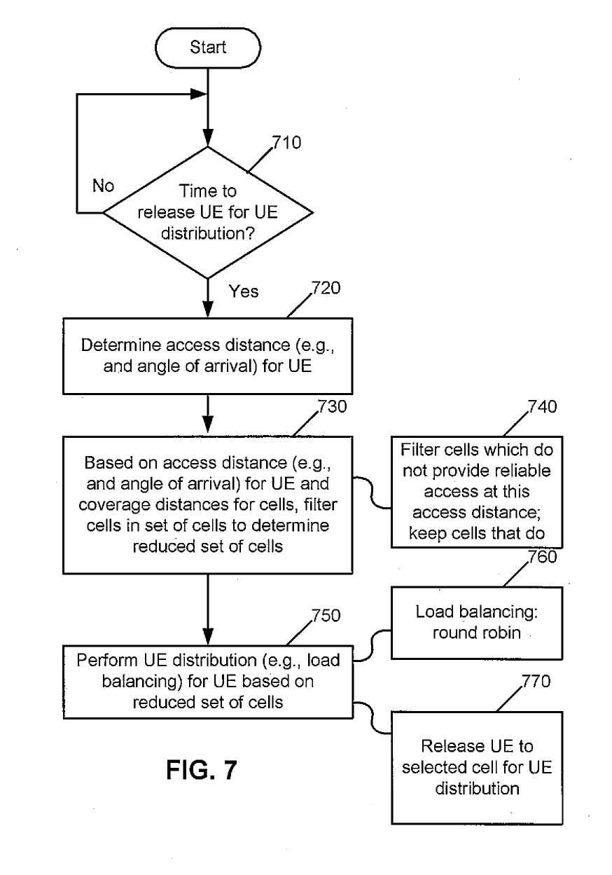

The following example of an algorithm is proposed to enhance the load balancing UEs at the time of transitioning to idle mode. This example will be described in part through reference to FIG. 7, which is a logic flow diagram for distributing (e.g., load balancing) UEs at the time of transitioning to idle mode based on access distance. Note that distributing UEs is performed typically for load balancing reasons, such that some “load” (e.g., UE accesses in the cell) are balanced among layers. Thus the terms “distributing” and “load balancing” are typically considered to be synonymous herein, but the distribution need not be limited to load balancing. FIG. 7 also illustrates the operation of an exemplary method, a result of execution of computer program instructions embodied on a computer readable memory, functions performed by logic implemented in hardware, and/or interconnected means for performing functions in accordance with exemplary embodiments. The eNB 170, e.g., under control in part by the distributing UEs at the time of transitioning to idle mode module 150, is assumed to perform the blocks in FIG. 7.

In response to a determination the UE should be released for distributing UEs at the time of transitioning to idle mode, the eNB 170 will determine the access distance 250 and possibly the angle of arrival 285 for the UE. The eNB 170 may use the UE Rx-Tx timing difference information monitored for each UE to determine the access distance 250, in an exemplary embodiment. Thus, in block 710, the eNB 170 determines whether it is time to release a UE for distributing UEs at the time of transitioning to idle mode. For instance, the eNB 170 could detect inactivity for the UE or an MME could initiate the release of the UE. If not (block 710=No), the eNB 170 waits (e.g., by returning to block 710) until it is time to release a UE.

If it is time to release the UE for distributing (e.g., load balancing) UEs at the time of transitioning to idle mode (block 710=Yes), the eNB 170 in block 720 determines the access distance 250 (e.g., and angle of arrival 285) for the UE 110.

Based on the UE's current access distance 250, the eNB 170 filters out the overlying frequencies, e.g., which do not provide reliable access at this access distance. The eNB 170 may use the data structure 600 described above for this process, although the invention is not limited to this data structure. This allows the eNB 170 to identify the candidate layers (e.g., frequencies(s) and corresponding cells) which have reliable coverage at the UE's current access distance. When both the operator-provisioned details (see coverage distance 650 of FIG. 6A) and self-learned coverage details (see coverage distance histogram 658) are available to the eNB 170, in an embodiment, eNB will use the self-learned coverage details.

More specifically, in block 730, the eNB, based on the access distance 250 (e.g., and/or angle of arrival) for the UE and the coverage distances 240 (or 650 or 658) for the cells, will filter cells in a set of cells to determine a reduced set of cells. The coverage area profile 695, which is one or both of the coverage distances 240 (or 650 or 658) and/or the angles of arrival 655 and 657, may be used in block 730. Note that the cells in the original set are a set of cells that partially or completely overlie each other. For instance, FIG. 2 illustrates two coverage areas 210-1 and 210-2, which overlie each other: coverage area 210-2 overlies part of coverage area 210-1; and coverage area 210-1 overlies coverage area 210-2. FIGS. 6A and 6B illustrate multiple overlying coverage areas 210 (as defined by coverage distances 650 or 658).

Block 730 characterizes this process as using cells (such as using cell IDs 610 in FIG. 6A or 6B) to perform this function. However, one could use, as shown in FIGS. 6A and 6B, EUTRAN frequencies 630 or frequency bands 620 for this process, or layers including, e.g., both frequencies 630/frequency bands 620 and corresponding cells. In block 740, the eNB 170 filters cells (e.g., using their cell IDs 610) which do not provide reliable access at this access distance and keeps the cells that do provide reliable access at this access distance. One indicator of reliable access for a cell is if the cell can provide idle mode access for the user equipment. Again, this could be characterized as filtering EUTRAN frequencies 630 or frequency bands 620. Additionally, the term “carrier” may also be used to refer to frequency bands such as the frequency bands 620 and the filtering may be performed using carriers.

Using the data structure 600-1 of FIG. 6A as an example, assume the access distance 250 of the user equipment 110 is 600 meters. According to the coverage distances 650, the cells 220 able to provide idle mode access and reliable access at 600 meters are the cells 220 having IDs 610 of C-G, whereas the cells 220 having IDs 610 of A and B are not able to provide idle mode access and reliable access at 600 meters. The cells 220 having IDs 610 of A and B would be filtered (block 740) from the set 660 of overlaying cells A-G to create the reduced set 670-1 of overlaying cells C-G. As another example, assume the access distance 250 of the user equipment 110 is 1000 meters. According to the coverage distances 650, the cells 220 able to provide idle mode access and reliable access at 1000 meters are the cells 220 having IDs 610 of E-G, whereas the cells 220 having IDs 610 of A-D are not able to provide idle mode access and reliable access at 1000 meters. The cells 220 having IDs 610 of A-D would be filtered (block 740) from set 660 of cells A-G to create the reduced set 670-2 of cells E-G.

The distributing the UEs at the time of transitioning to idle mode is performed on the reduced set 670 rather than all the overlying carriers and their corresponding cells in the original set 660. Thus, in block 750, the eNB 170 performs distributing the UEs at the time of transitioning to idle mode for the UE based on the reduced set 670 of cells. Such distributing may be performed using many different techniques such as (block 760) load balancing techniques including, for instance, round robin load balancing (where the cells are selected in a circular order, e.g., 1, 2, 3, then 1, 2, 3 again). In block 770, the eNB 170 can release the UE 110 to a selected one of the cells in the reduced set of cells for distributing UEs at the time of transitioning to idle mode. When UE is released by the eNB, the eNB could specify the frequencies the UE can idle on and also set the priorities for different frequencies. Then the UE will use the information provided by eNB and reselect a frequency. The UE is released when the UE is in connected mode. Due to inactivity, the eNB could release the UE. As another example, the MME also could initiate the release of the UE.

Note that an eNB 170 can share each coverage area profile of a cell across overlaying cells for the base station. That is, if the single eNB 170 creates multiple overlaying cells, the coverage area profiles 690 (with coverage areas 650/658 and/or angles of arrival 655/657) may be shared across the overlaying cells. In another example, multiple base stations may create the multiple overlaying cells and the base station(s) may share each coverage area profile 690 of a cell across these multiple base stations. That is, one specific base station may share its coverage area profiles 695 with other base stations, and those base stations may share their coverage area profiles 695 with the specific base station.

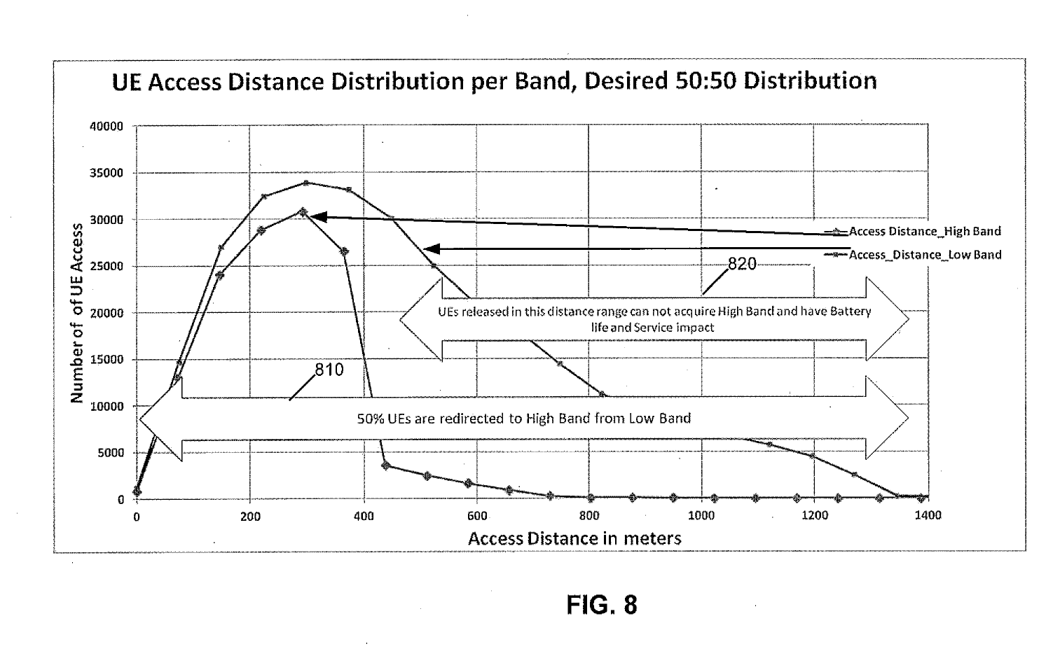

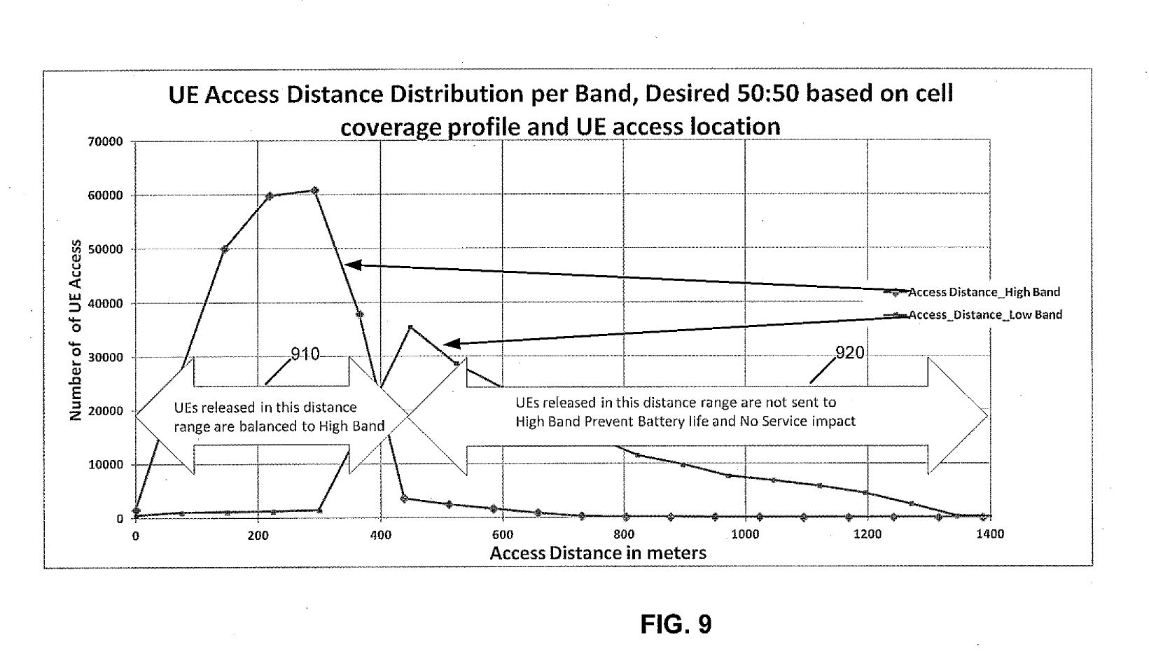

The example charts described below show the benefit of the proposed examples and the set of UEs where the negative impact can be prevented. These charts are derived from field data on UEs access on high and low bands. FIG. 8 is a graph illustrating behavior without this invention, and FIG. 9 is a graph illustrating behavior with this invention.

In FIG. 8, as indicated by reference 810, all the UEs are redirected to high band from low band, e.g., with a desired 50:50 distribution. Consequently, as indicated by reference 820, UEs released in this distance range (about 450 meters to 1400 meters) cannot acquire high band and have battery life and service impacts. By contrast, in FIG. 9, as indicted by reference 910, UEs released in this distance range (from zero to about 450 meters) are balanced to high band. Meanwhile, as indicated by reference 920, UEs released in this distance range (from about 450 meters to 1400 meters) are not sent to high band and instead sent to low band. This improves battery life and has no service impact.

The examples of embodiments herein may be used by legacy 3GPP and LTE operators. Both macro and small cell deployment will benefit from the examples. An exemplary embodiment proposes inclusion of access distances and potentially angle of arrival to make a decision on a suitable candidate set of overlying carriers. In addition, GPS based location can be used to get the UE's current location accurately, but such an approach does add additional signaling to the UE and may not be available in all areas. Alternatively, the CQI measurements reported from the UE can be also used to get a distance estimate.

The embodiments provide one or more of the following benefits and technical effects over existing solutions:
The approaches increase the reliability of acquiring the overlying carrier selected by load balancing UEs at the time of transitioning to idle mode algorithm;
The approaches do not require any additional over-the-air signaling, thus do not impact the UE battery life and system signaling capacity;
The battery life impact due to load balancing to non-available carriers (e.g., 6-10%) is eliminated and this result creates a better end-user experience;
The examples reduce the possibility of the time window where the UE does not have access to RF due to non-optimal balancing approaches; and/or
The operator is able to achieve true load balancing across the overlying layers effectively and thus overall a better end-user experience in a geographical area.

Examples of possible embodiments include the following. A method, comprising: selecting, from a set of overlaying cells using one or more radio access technologies and a plurality of different frequencies and whose coverage areas for the cells in the set partially or completely overlay each other, a reduced set of overlaying cells to provide access to user equipment, wherein the selection is based on location of the user equipment within the overlaying cells and estimates of coverage areas of the overlaying cells; and performing distribution of user equipment across the selected overlaying cells based on a desired statistical distribution for the user equipment across the cells in the reduced set of cells, wherein the desired statistical distribution takes into account the one or more radio access technologies and the plurality of different frequencies.

Another example includes the method of the previous paragraph, wherein performing distribution of user equipment across overlaying cells further comprises selecting one of the cells in the reduced set of the cells and moving the user equipment to the selected cell. Another example is the method of this paragraph, wherein performing distribution of user equipment further comprises selecting one of the cells in the reduced set of the cells based on a share of user equipment to be distributed to each cell in the set of cells and moving the user equipment to the selected cell.

A further example includes the methods of the previous paragraphs, wherein each estimated coverage area is defined in part by a corresponding access distance range and selecting cells further comprises of determining an access distance for the user equipment and using the cells which have access distance range indicating that the cells are able to provide access for the user equipment based upon the determined access distance.

Another example is the method of the previous paragraph, wherein each estimated coverage area is defined in part by a corresponding range for angles of arrival for a cell and wherein selecting further comprises determining an angle of arrival of the user equipment and using the cells which have ranges for angles of arrival indicating the cells can provide access for the user equipment based upon the determined angle of arrival.

Another example is the method of the previous paragraph, wherein each estimate of the coverage area of each cell is derived based on stored measurement data of user equipment distance and of angle of arrival during access in the cell and handover traffic by the user equipment in the cell.

Another example is the method of the previous paragraph, further comprising sharing information defining a coverage area for a cell across overlaying cells for a base station. A further example is the method of the previous paragraph, further comprising sharing information defining a coverage area of a cell across multiple base stations each of which has at least one of the overlaying cells.

Another example is the methods of the previous three paragraphs, further comprising determining one or both of access distance or angle of arrival for the user equipment by using one or more of the following: reception-transmission difference information for the user equipment; global positioning system information received from the user equipment; channel quality information measurements reported from the user equipment; or phase measurement at the base station antenna.

A further example includes the methods of the previous paragraphs, wherein the selecting the reduced set of overlaying cells and the performing distribution are performed during a process resulting in transitioning the user equipment to an idle mode.

Another example is an apparatus comprising means for performing any of the methods of the previous paragraphs. For instance, the apparatus could comprise: means for selecting, from a set of overlaying cells using one or more radio access technologies and a plurality of different frequencies and whose coverage areas for the cells in the set partially or completely overlay each other, a reduced set of overlaying cells to provide access to user equipment, wherein the selection is based on location of the user equipment within the overlaying cells and estimates of coverage areas of the overlaying cells; and means for performing distribution of user equipment across the selected overlaying cells based on a desired statistical distribution for the user equipment across the cells in the reduced set of cells, wherein the desired statistical distribution takes into account the one or more radio access technologies and the plurality of different frequencies.

An exemplary apparatus includes one or more processors and one or more memories including computer program code. The one or more memories and the computer program code are configured to, with the one or more processors, cause the apparatus to perform any of the methods of the previous paragraphs.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1. A computer-readable medium may comprise a computer-readable storage medium (e.g., memories 125, 155, 171 or other device) that may be any media or means that can contain or store the instructions for use by or in connection with an instruction execution system, apparatus, or device, such as a computer. A computer-readable storage medium does not comprise propagating signals.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:

2G second generation

3G third generation

3GPP third generation partnership project

AoA angle of arrival

BTS base transceiver station

CQI channel quality information

CDMA code-division multiple access

DL downlink (from base station to UE)

eNB or eNodeB base station, evolved Node B (e.g., LTE base station)

EUTRAN evolved universal terrestrial radio access network

GHZ giga-Hertz

ID identification

GPS global positioning system

km kilometers

LTE long term evolution

MHz mega-Hertz

MME mobility management entity

NCE network control element

RAT radio access technology

Rel release

RF radio frequency

RNC radio network control

RRC radio resource control

Rx reception or receiver

SGW serving gateway

SON self-organizing network

TA timing advance

TS technical specification

Tx transmission or transmitter

UE user equipment (e.g., a mobile wireless device)

UL uplink (from UE to base station)

What is claimed is:

1. A method, comprising:
selecting, from a set of overlaying cells using one or more radio access technologies and a plurality of different frequencies and whose coverage areas for the cells in the set partially or completely overlay each other, a reduced set of overlaying cells to provide access to user equipment, wherein the selection is based on location of the user equipment within the overlaying cells and estimates of coverage areas of the overlaying cells; and
performing distribution of user equipment across the selected overlaying cells based on a desired statistical distribution for the user equipment across the cells in the reduced set of cells, wherein the desired statistical distribution takes into account the one or more radio access technologies and the plurality of different frequencies.

2. The method of claim 1, wherein performing distribution of user equipment across overlaying cells further comprises selecting one of the cells in the reduced set of the cells and moving the user equipment to the selected cell.

3. The method of claim 2, wherein performing distribution of user equipment further comprises selecting one of the cells in the reduced set of the cells based on a share of user equipment to be distributed to each cell in the set of cells and moving the user equipment to the selected cell.

4. The method of claim 1, wherein each estimated coverage area is defined in part by a corresponding access distance range and selecting cells further comprises of determining an access distance for the user equipment and using the cells which have access distance range indicating that the cells are able to provide access for the user equipment based upon the determined access distance.

5. The method of claim 4, wherein each estimated coverage area is defined in part by a corresponding range for angles of arrival for a cell and wherein selecting further comprises determining an angle of arrival of the user equipment and using the cells which have ranges for angles of arrival indicating the cells can provide access for the user equipment based upon the determined angle of arrival.

6. The method of claim 5, wherein each estimate of the coverage area of each cell is derived based on stored measurement data of user equipment distance and of angle of arrival during access in the cell and handover traffic by the user equipment in the cell.

7. The method of claim 6, farther comprising sharing information defining a coverage area for a cell across overlaying cells for a base station.

8. The method of claim 6, further comprising sharing information defining a coverage area of a cell across multiple base stations each of which has at least one of the overlaying cells.

9. The method of claim 5, further comprising determining one or both of access distance or angle of arrival for the user equipment by using one or more of the following: reception-transmission difference information for the user equipment; global positioning system information received from the user equipment; channel quality information measurements reported from the user equipment; or phase measurement at the base station antenna.

10. The method of claim 1, wherein the selecting the reduced set of overlaying cells and the performing distribution are performed during a process resulting in transitioning the user equipment to an idle mode.

11. An apparatus, comprising:
one or more processors; and
one or more memories including computer program code,
the one or more memories and the computer program code configured, with the one or more processors, to cause the apparatus to perform at least the following:
selecting, from a set of overlaying cells using one or more radio access technologies and a plurality of different frequencies and whose coverage areas for the cells in the set partially or completely overlay each other, a reduced set of overlaying cells to provide access to user equipment, wherein the selection is based on location of the user equipment within the overlaying cells and estimates of coverage areas of the overlaying cells; and
performing distribution of user equipment across the selected overlaying cells based on a desired statistical distribution for the user equipment across the cells in the reduced set of cells, wherein the desired statistical distribution takes into account the one or more radio access technologies and the plurality of different frequencies.

12. The apparatus of claim 11, wherein performing distribution of user equipment across overlaying cells further comprises selecting one of the cells in the reduced set of the cells and moving the user equipment to the selected cell.

13. The apparatus of claim 12, wherein performing distribution of user equipment further comprises selecting one of the cells in the reduced set of the cells based on a share of user equipment to be distributed to each cell in the set of cells and moving the user equipment to the selected cell.

14. The apparatus of claim 11, wherein each estimated coverage area is defined input by a corresponding access distance range and selecting cells further comprises of determining an access distance for the user equipment and using the cells which have access distance range indicating that the cells are able to provide access for the user equipment based upon the determined access distance.

15. The apparatus of claim 14, wherein each estimated coverage area is defined in part by a corresponding range for angles of arrival for a cell and wherein selecting further comprises determining an angle of arrival of the user equipment and using the cells which have ranges for angles of arrival indicating the cells can provide access for the user equipment based upon the determined angle of arrival.

16. The apparatus of claim 15, wherein each estimate of the coverage area of each cell is derived based on stored measurement data of user equipment distance and of angle of arrival during access in the cell and handover traffic by the user equipment in the cell.

17. The apparatus of claim 16, wherein the one or more memories and the computer program code are further configured, with the one or more processors, to cause the apparatus to perform at least the following: sharing information defining a coverage area for a cell across overlaying cells for a base station.

18. The apparatus of claim 16, wherein the one or more memories and the computer program code are further configured, with the one or more processors, to cause the apparatus to perform at least the following: sharing information defining a coverage area of a cell across multiple base stations each of which has at least one of the overlaying cells.

19. The apparatus of claim 15, wherein the one or more memories and the computer program code are further configured, with the one or more processors, to cause the apparatus to perform at least the following: determining one or both of access distance or angle of arrival for the user equipment by using one or more of the following: reception-transmission difference information for the user equipment; global positioning system information received from the user equipment; channel quality information measurements reported from the user equipment; or phase measurement at the base station antenna.

20. The apparatus of claim 11, wherein the selecting the reduced set of overlaying cells and the performing distribution are performed during a process resulting in transitioning the user equipment to an idle mode.

21. A computer program product comprising a computer-readable storage medium bearing computer program code embodied therein for use with a computer, the computer program code comprising:
code for selecting, from a set of overlaying cells using one or more radio access technologies and a plurality of different frequencies and whose coverage areas for the cells in the set partially or completely overlay each other, a reduced set of overlaying cells to provide access to user equipment, wherein the selection is based on location of the user equipment within the overlaying cells and estimates of coverage areas of the overlaying cells; and
code for performing distribution of user equipment across the selected overlaying cells based on a desired statistical distribution for the user equipment across the cells in the reduced set of cells, wherein the desired statistical distribution takes into account the one or more radio access technologies and the plurality of different frequencies.
